(19) United States
(12) Patent Application Publication
(10) Pub. No.: US 2023/0225293 A1
(43) Pub. Date: Jul. 20, 2023

(54) INTERNET OF THINGS-BASED DEVICE AND METHOD FOR PROVIDING COMPANION ANIMAL COMMUNICATION FUNCTION, AND USER TERMINAL

(71) Applicant: Jung Hun PARK, Seoul (KR)

(72) Inventor: Jung Hun PARK, Seoul (KR)

(21) Appl. No.: 18/001,451

(22) PCT Filed: Jun. 8, 2021
(86) PCT No.: PCT/KR2021/007106

§ 371 Date: Dec. 9, 2022

(30) Foreign Application Priority Data
Jun. 12, 2020 (KR) 10-2020-0071789

(51) Int. Cl. A01K 29/00; A01K 5/02; A01K 15/02; H04N 7/14

(52) U.S. Cl. CPC A01K 29/00; A01K 5/02; A01K 15/02; H04N 7/147

(57) ABSTRACT

Disclosed herein are a device and method for providing a function for communication with a companion animal based on the Internet of Things which remotely control an apparatus capable of identifying a desire of the companion animal and satisfying the desire of the companion animal, the device includes a desire signal delivery unit configured to receive a desire signal of a companion animal and deliver the desire signal through a companion animal communication-dedicated application running in a user terminal, a remote control signal reception unit configured to receive a remote control signal of a desire-satisfying device which matches the desire signal delivered by the desire signal delivery unit through the companion animal communication-dedicated application running in the user terminal, and a remote control signal delivery unit configured to deliver the remote control signal received by the remote control signal reception unit to the desire-satisfying device.

### TECHNICAL FIELD

The present invention relates to a device and method for providing a function for communication with a companion animal based on the Internet of Things, and a user terminal, and more particularly, to a device and method for providing a function for communication with a companion animal based on the Internet of Things, and a user terminal which remotely control the Internet of Things apparatus capable of recognizing and satisfying a desire of the companion animal.

### BACKGROUND ART

In general, recently, various industrial developments have become more advanced, the quality of life has been improved, and nuclear families and single-person households have increased. Therefore, as the number of people raising companion animals that are always pure in nature increases, there has been an increased awareness related to companion animals, such as re-recognizing the conventional value of companion animals and being proposed to call them companion animals.

Reflecting this trend, businesses related to cafes and hotels for companion animals, including veterinary hospitals, are being thriving, and the market size related to companion animals is expanding rapidly, such that many stores are being opened to sell companion animal clothes, accessories, food, toys, etc., or to provide beauty care for companion animals and even companion animal-related TV programs are being popularly broadcast.

Therefore, many people who love companion animals desire and strive to communicate with their companion animals, and various methods have been introduced to study the behavior characteristics of animals and understand their intentions.

Documents of the related art related to the present invention include Korean Patent Application Publication No. 10-2018-0090637 and Korean Patent Application Publication No. 10-2015-011310.

### DISCLOSURE

### Technical Problem

The present invention is derived from this background, and an object of the present invention is to provide a device and method for providing a function for communication with a companion animal based on the Internet of Things, the device and method being capable of providing functions using an IoT apparatus such as providing feed, snacks, toys, and video calls so as to identify the contents desired by the companion animal at a remote location and satisfy the desire accordingly, thereby increasing intimacy with the companion animal, relieving separation anxiety of the companion animal, preventing depression of the companion animal, and increasing the amount of exercise of the companion animal.

In addition, an object of the present invention is to provide a device and method for providing a function for communication with a companion animal based on the Internet of Things, the device and method being capable of not only immediately satisfying the desire of a companion dog, but also improving the communication skills of an owner who considers the companion dog to be an intimate family member with the companion dogs, by anthropomorphizing the companion dog to perform the communication in a chat format.

### Technical Solution

The present invention for achieving the above-described technical objects includes the following configuration.

That is, a device for providing a function for communication with a companion animal based on the Internet of Things according to an embodiment of the present invention includes: a desire signal delivery unit configured to receive a desire signal of a companion animal and deliver the desire signal through a companion animal communication-dedicated application running in a user terminal; a remote control signal reception unit configured to receive a remote control signal of a desire-satisfying device which matches the desire signal delivered by the desire signal delivery unit through the companion animal communication-dedicated application running in the user terminal; and a remote control signal delivery unit configured to deliver the remote control signal, received by the remote control signal reception unit, to the desire-satisfying device.

Meanwhile, a method of providing a function for communication with a companion animal based on the Internet of Things performed by a device for providing a function for communication with a companion animal based on the Internet of Things including a desire signal delivery unit, a remote control signal reception unit, and a remote control signal delivery unit, includes: receiving, by the desire signal delivery unit, a desire signal of companion animal and delivering, by the desire signal delivery unit, the desire signal through a companion animal communication-dedicated application running in a user terminal; receiving, by the remote control signal reception unit, a remote control signal of a desire-satisfying device, the remote control signal matching the desire signal delivered by the desire signal delivery unit through the companion animal communication-dedicated application running in the user terminal; and delivering, by the remote control signal delivery unit, the remote control signal to the desire-satisfying device, the remote control signal being received by the remote control signal reception unit.

### Advantageous Effects

According to the present invention, it is possible to provide functions using IoT apparatus such as feeding, serving snacks, providing toys, and video calls so as to identify the contents desired by the companion animal at a remote location and satisfy the desire, thereby increasing intimacy with the companion animal, and it is also possible to continuously check and feedback the needs of the companion animal, thereby relieving separation anxiety of the companion animal, preventing depression of the companion animal, and increasing the amount of exercise of the companion animal.

In addition, it is possible to prevent an overeating by remotely controlling a feeder of the companion animal in real time, and help a health management through dietary adjustment by adjusting the amount of feeding. Even though a feed is provided every predetermined time by using an existing feeder, the companion animal frequently binge-eats in the evening and vomits. Therefore, a device for providing a function for communication with a companion animal based on the Internet of Things according to an embodiment of the present invention may prevent the companion animal from overeating.

In addition, it is possible to provide a device and method for providing a function for communication with a companion animal based on the Internet of Things, which can not only immediately satisfy the desire of companion dog, but also improve the communication skills of an owner who considers a companion dog to be an intimate family member with the companion dogs, by anthropomorphizing the companion dogs to perform the communication in a chat format. Further, it is possible to prevent the occurrence of abandoned companion dogs by creating intimacy with the companion animals, thereby accordingly reducing the social and economic losses.

Furthermore, it is possible to provide a medium through which the companion dog is able to express its own desires and call the owner together with barking when calling the owner, thereby performing a function of preventing noise between floors in multi-family houses through barking reduction effect.

### DESCRIPTION OF DRAWINGS

FIG. 1 is an exemplified view for explaining an overall operation of a device for providing a function for communication with a companion animal based on the Internet of Things according to an embodiment of the present invention.

FIG. 2 is a block diagram illustrating a configuration of the device for providing a function for communication with a companion animal based on the Internet of Things according to the embodiment of the present invention.

FIGS. 3 to 5 are exemplified views illustrating an executed screen of a companion animal communication-dedicated application according to the embodiment of the present invention.

FIGS. 6 and 7 are flowcharts for explaining a method of providing a function for communication with a companion animal based on the Internet of Things according to an embodiment of the present invention.

### EXPLANATION OF REFERENCE NUMERALS AND SYMBOLS

### Best Mode

It should be noted that technical terms used in the present invention are used to just describe a specific exemplary embodiment and do not intend to limit the scope of the present invention. Further, unless the technical terms used in the present invention are particularly defined as other meanings in the present invention, the technical terms should be interpreted as meanings generally appreciated by those skilled in the art and should not be interpreted as excessively comprehensive meanings or excessively reduced meanings.

Hereinafter, an exemplary embodiment according to the present invention will be described in detail with reference to the accompanying drawings.

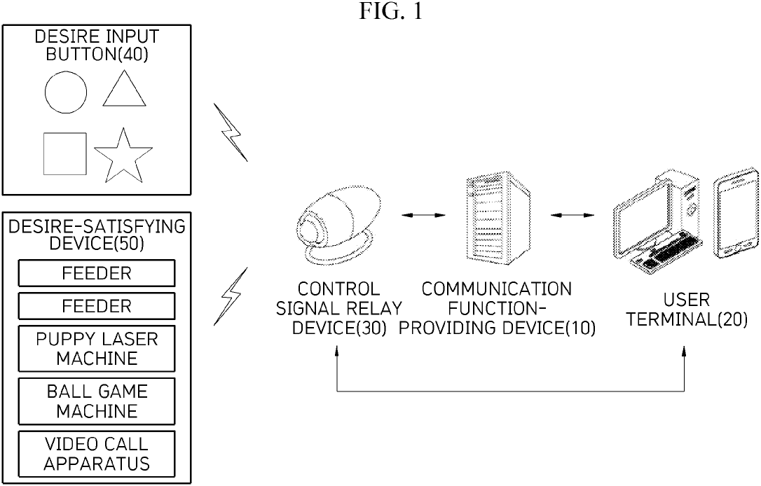

FIG. 1 is an exemplified view for explaining an overall operation of a device for providing a function for communication with a companion animal based on the Internet of Things according to an embodiment of the present invention.

A device 10 for providing a function for communication with a companion animal based on the Internet of Things according to an embodiment of the present invention is a device which is capable of actually sympathizing/contacting/communicating with a companion animal by receiving a desire of the companion animal through a push button and transmitting the desire to a messenger application such as Kakao Talk of a user terminal 20 such as a smartphone through developing an apparatus and a platform for communicating with the companion animal.

The device 10 for providing a function for communication with a companion animal based on the Internet of Things may allow a companion dog to express its desire by training through a desire input button which has different shapes of buzzers and collect and deliver information related to the desire of the companion dog to a user and provide a communicable conversation window through which the user identifies the desire of the companion animal and remotely gives feedback to the companion animal with voice, photo, etc.

In this case, the companion animal may be trained to express the desire using the desire input button as a desire expressing method.

Therefore, the trained companion animal expresses his/her desire with the push button, and the Internet of Things technology is introduced to check the desire of the companion animal and to respond thereto even though the owner is not at home.

When the desire input button is pressed, a control signal relay device 30 (main terminal) transmits a content from the desire input button to a communication function-providing device 10 (service server), and thereafter the communication function-providing device 10 sends the refined content to a companion animal communication-dedicated application of the user terminal. In this case, the companion animal communication-dedicated application receives the content in the form of a messenger to enable two-way communication. Alternatively, the two-way communication may be implemented to be in conjunction with an existing chat-only application running in the user terminal 20.

According to another embodiment of the present invention, when the desire input button is pressed, the control signal relay device transmits a button input signal to the user terminal 20 via the communication function-providing device 10. In this case, the communication function-providing device 10 simply serves to deliver the button input signal of the desire input button received from the control signal relay device 30 to the user terminal 20. Then, the companion animal communication-dedicated application installed in the user terminal 20 may make and refine the input of the desire input button as data, thereby allowing a user to communicate with the companion animal as if the companion animal makes a conversation using a real language.

That is, when the companion animal expresses the desire, acquired by training, through the button, the communication function-providing device 10 makes and refines the button input as data, and the companion animal communication-dedicated application of the user terminal 20 may allow the user to communicate with the companion animal as if the companion animal were talking using a real language.

More specifically, the desire input button 40 is implemented to have different shaped buttons. According to the embodiment, the button may be preferably implemented in the number, shapes, and colors that the companion dog may select by training. The number, shapes, and colors of the desire input buttons may be varied.

For example, buttons may be matched with respective situations that the companion dog may recognize, such as pressing a ☆ shaped-button for food, pressing a o shaped-button for a play, pressing a ⧠ shaped-button for a video call function with the owner, and pressing a Δ shaped-button for the turn-on of an air conditioner or TV. In addition, words used in real life, such as mom, my master, let’s..., please, give me ... and the like, may be matched.

For example, the desire input button 40 may include a speaker to play a recorded content or a stored special sound when the button is pressed. In addition, the desire input button 40 may include a light-emitting device such as an LED to turn on when the button is pressed. The shapes and colors of the desire input button 40 is implemented so that it is easy for the companion animal to recognize. In addition, the desire input button 40 includes a short-range wireless communication module such as a Bluetooth module for transmitting a signal to the control signal relay device 30, the signal being obtained by sensing that the corresponding button has been pressed when the button is pressed.

The control signal relay device 30 includes a camera and a communication module. In addition, the control signal relay device 30 may include at least one of various sensor modules capable of checking the status of the companion dog, such as an ultrasonic sensor, a sound detection sensor, an NFC sensor, and an RFID sensor.

According to the embodiment, the communication module of the control signal relay device 30 performs a short-range wireless communication function such as a wireless LAN, Bluetooth, or an infrared sensor. In addition, the communication module includes a technical configuration that may transmit a remote controller signal to a home appliance such as a TV or an air conditioner, including an IR sensor. According to the embodiment, the control signal relay device 30 may transmit a video shot by the camera to the communication function-providing device 10 or the user terminal 20. In this case, the user terminal 20 may communicate with a plurality of control signal relay devices 30.

In addition, the control signal relay device 30 includes the communication module that performs network communication with the communication function-providing device 10. According to the embodiment, the control signal relay device 30 transmits the input signal of the desire input button 40 to the communication function-providing device 10 so that it may be determined which of the desire input buttons 40 is pressed, and transmits a remote control signal received through the communication function-providing device 10 to a home appliance apparatus, that is, the desire-satisfying device 50 that may satisfy appetite or play desires.

Examples of the desire-satisfying device 50 include various apparatuses that may operate in response to the remote control signal. For example, the desire-satisfying device 50 includes one of a feeder, a snack feeder, a puppy laser machine, a ball game machine, and a video call apparatus. However, the desire-satisfying device 50 is not limited thereto but is interpreted to encompass various devices and apparatuses that may operate in response to the remote control signal and satisfy the desire of the companion animal.

The communication function-providing device 10 is implemented as a service server that includes the control signal relay device 30, the user terminal 20 and the wireless LAN communication module for receiving data. According to the embodiment, the communication function-providing device 10 may perform machine learning on time, the number of times, a language content, etc., extract calls and request messages with natural language processing, and provide the calls and request messages to the user terminal 20. In addition, the communication function-providing device 10 transmits a video or text in a chat format to the user terminal 20.

The user terminal 20 may be applied to various terminals, such as a smart phone, a portable terminal, a mobile terminal, a foldable terminal, a personal digital assistant (PDA), a portable multimedia player (PMP) terminal, a telematics terminal, a navigation terminal, a personal computer, a laptop computer, a slate PC, a tablet PC, an Ultrabook, a wearable device (for example, including a watch-type terminal (Smartwatch), a glass-type terminal (Smart Glass), and a Head Mounted Display (HMD)), a Wibro terminal, an Internet Protocol Television (IPTV) terminal, a smart TV, a digital broadcasting terminal, an Audio Video Navigation (AVN) terminal, an Audio/Video (A/V) system, a flexible terminal, and a digital signage device.

According to the embodiment, the user terminal 20 is carried by the owner of the companion animal. The companion animal communication-dedicated application executed in the user terminal 20 may provide a chat function with the companion animal, and transmit a voice to the control signal relay device 30, or perform a video call function. In addition, the companion animal communication-dedicated application may generate and transmit a remote control signal to the desire-satisfying device 50 provided in the house.

In addition, the communication function-providing device 10 may provide a business model that may generate revenue by receiving a monthly service fee according to the interworking with a companion animal communication service (API: application programming interface service) according to an embodiment from device companies that may apply the desire-satisfying device, such as existing companion animal feeder, toy, and healthcare companies.

Specifically, when there is a need for a button training for the companion animal, the communication function-providing device 10 may allow an expert to visit home for training the companion dog, or may introduce a nearby place for the companion dog training to provide a necessary educational information so that the companion dog takes the button training, or to make an appointment for expert training.

In addition, the communication function-providing device 10 may provide a business model that may generate revenue from advertising fees by providing an advertising function for pet supplies such as pet hotels, pet grooming salons, and pet feeds through the companion animal communication-dedicated application running in the user terminal 20. In this case, when the advertising function is provided, the advertisement may be configured so that the companion animal seems like requesting a certain desire in a conversational format, thereby maximizing an advertising effect for the owner raising the companion animal.

According to the embodiment, the companion animal communication-dedicated application of the user terminal 20 may be connected to and communicated with the control signal relay device 30 provided in the pet hotel.

That is, when the companion animal is left in the pet hotel provided with the control signal relay device 30, the companion dog is placed in an independent space of the pet hotel and the button device, the desire-satisfying device, and the like are provided therein. And when the button device provided in the pet hotel is set as the existing desire buttons, patterns, and the like that the companion dog uses, there is an effect of being capable of communicating with the companion animal in the pet hotel in the same way.

According to another aspect of the present invention, it is also possible that the communication function-providing device 10 is integrally equipped in the user terminal 20. In this case, the communication function-providing device 10 is implemented to perform the function of the communication function-providing device 10 through the companion animal communication-dedicated application equipped in the user terminal 20.

Therefore, data usage costs related to running physically separate service servers may be saved.

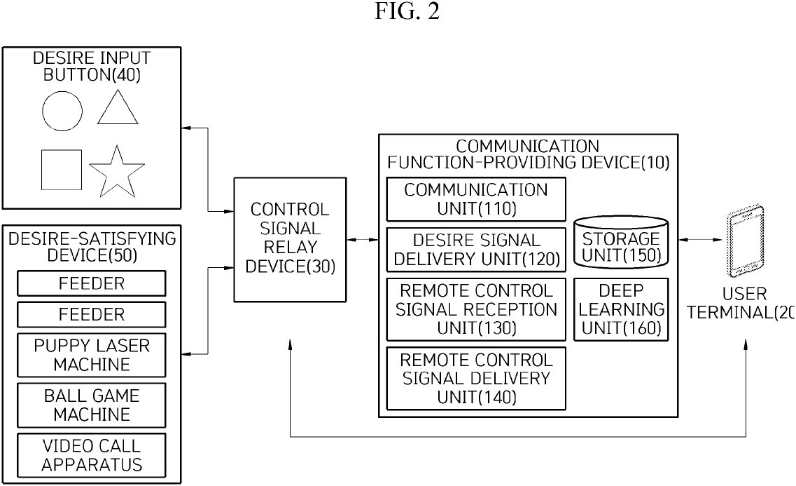

FIG. 2 is a block diagram illustrating a configuration of the device for providing a function for communication with a companion animal based on the Internet of Things according to the embodiment of the present invention.

As illustrated in FIG. 2, the communication function-providing device 10 according to the embodiment includes a communication unit 110, a desire signal delivery unit 120, a remote control signal reception unit 130, a remote control signal delivery unit 140, a storage unit 150, and a deep learning unit 160.

A communication method supported by the communication unit 110 is not limited, and data transmission/reception may be performed in a short-range wireless communication method between the apparatuses as well as a communication method utilizing a communication network (for example, a mobile communication network, a wired Internet, a wireless Internet, a broadcasting network) that a network may include.

Here, the network may include any one or more of networks such as a personal area network (PAN), a local area network (LAN), a campus area network (CAN), a metropolitan area network (MAN), a wide area network (WAN), a broadband network (BBN), an Internet, and the like.

In addition, the network may include any one or more of network topologies including a bus network, a star network, a ring network, a mesh network, a star-bus network, a tree or hierarchical network, and the like, but not limited thereto.

The desire signal delivery unit 120 receives a desire signal of the companion animal with the signal of the desire input button 40 through the communication unit 110 and transmits the desire signal of the companion animal so that the user may identify the desire content of the companion animal through the companion animal communication-dedicated application running in the user terminal 20.

The desire signal delivery unit 120 receives the desire signal according to the button input set differently for each desire of the companion animal.

In one aspect, the desire signal delivery unit 120 converts the desire signal of the companion animal into a colloquial language and deliver the converted desire signal, through a chat function of the companion animal communication-dedicated application.

In addition, the desire signal delivery unit 120 identifies a keyword according to the desire signal of the companion animal, selects a sentence including the keyword from among the pre-stored conversational sentences, and delivers the sentence through the chat function of the companion animal communication-dedicated application.

For example, when the input signal of the o-shaped button matched with a keyword ‘feed’ is received, the desire signal delivery unit 120 selects one of the colloquial sentences that may express the desire such as ‘I’m hungry’ and ‘It’s time to eat! Please be with me’ and delivers the selected sentence through a chat window of the user terminal.

According to a further aspect of the present invention, the desire signal delivery unit 120 converts the desire signal of the companion animal into the colloquial language and delivers the converted desire signal, through the chat function of the companion animal communication-dedicated application on the basis of a companion animal shooting video received from the camera.

In this case, by the user setting, the desire signal of the companion animal may be converted into the colloquial language and delivered, or delivered as a state notification message without being converted into the colloquial language. That is, the desire signal of the companion animal may be simply delivered as the notification message in the form of keywords or sentences through which a motion state or desire state of the companion dog may be recognized.

In addition, the desire signal delivery unit 120 according to the embodiment provides additional information to identify which companion animal has pressed the button when a plurality of companion animals is raised. A companion animal which presses the button among the plurality of companion animals is identified on the basis of a companion animal shooting video, or the companion animal shooting video is provided to the user terminal 20 so that the user may directly check the companion animal which presses the button.

According to the embodiment, the desire input button 40 or the control signal relay device 30 may include a chip recognition unit which is capable of recognizing an internal chip or an external chip for recognizing the companion animal. The desire signal delivery unit 120 may receive a chip recognition signal from the chip recognition unit of the control signal relay device 30 and deliver an identification information of the companion animal to the user terminal 20.

Therefore, it is possible to accurately identify which companion animal has pressed the button, and accordingly, to manage the health and diet of each companion animal.

For example, in the video shot by the camera, when the companion animal waits around the feeder over a predetermined period of time, or stays for a predetermined period of time on a urine pad, the desire signal delivery unit 120 may output a message indicating appetite such as “I’m hungry”, or generate and output a message such as “Cool” after defecation. In this case, the camera may be equipped on the control signal relay device 30. However, the present invention is not limited thereto.

The remote control signal reception unit 130 receives the remote control signal to control the operation of the desire-satisfying device 50 that matches with the desire signal delivered from the desire signal delivery unit 120 through the companion animal communication-dedicated application running in the user terminal 20.

The remote control signal includes control signals for controlling the operations of various desire-satisfying devices 50, such as a signal for controlling the feed supply of the feeder, a signal for controlling the snack supply of the snack feeder, and a signal for operating the ball game machine.

The remote control signal delivery unit 140 delivers the remote control signal received by the remote control signal reception unit 130 to the desire-satisfying device 50 via the control signal relay device 30.

The desire-satisfying device 50 may be implemented as the feeder or snack feeder for satisfying the appetite of the companion animal. In addition, the desire-satisfying device 50 may be implemented as a play-aid such as a puppy laser machine or the ball game machine to satisfy the desire for play of the companion animal. In addition, the desire-satisfying device 50 may be implemented as the video call apparatus to satisfy the desire to miss the owner of the companion animal.

Alternatively, the desire-satisfying device 50 may be implemented to output a user’s voice through a speaker equipped on the control signal relay device 30 or a physically separated speaker to give feedback on the desire of the companion animal. However, the present invention is not limited thereto, but is interpreted to encompass a variety of apparatuses. In this case, the video call apparatus may be implemented as a function physically equipped on the control signal relay device 30.

The storage unit 150 may include at least one storage medium of a flash memory type, a hard disk type, a multimedia card micro type, a card type memory (e.g., SD or XD memory, etc.), a magnetic memory, a magnetic disk, an optical disk, a random access memory (RAM), a static random access memory (SRAM), a read-only memory (ROM), an electrically erasable programmable read-only memory (EEPROM), and a programmable read-only memory (PROM) .

According to the embodiment, the storage unit 150 stores a program for recognizing the desire of the companion animal according to the desire signal input, a program necessary for driving the companion animal communication-dedication application running in the user terminal 20, a program necessary for delivering the remote control signal received from the user terminal 20 to the control signal relay device 30 matched with the user, and data necessary for driving the programs.

The deep learning unit 160 may include a deep learning model learning unit and a model management unit. According to the embodiment, the deep learning model learning unit learns conversation contents through the user’s chat application by machine learning to generate and store a deep learning model in the storage unit 150.

In addition, the model management unit updates the deep learning model by performing machine learning on the keywords included in the sentences, a conversation content, and a question and answer content between the user and the other party used in the chat application, thereby optimizing the deep learning model for colloquially expressing the desire of the companion animal through the chat function of the companion animal communication-dedicated application. Therefore, the user may chat with the companion animal in a more realistic manner.

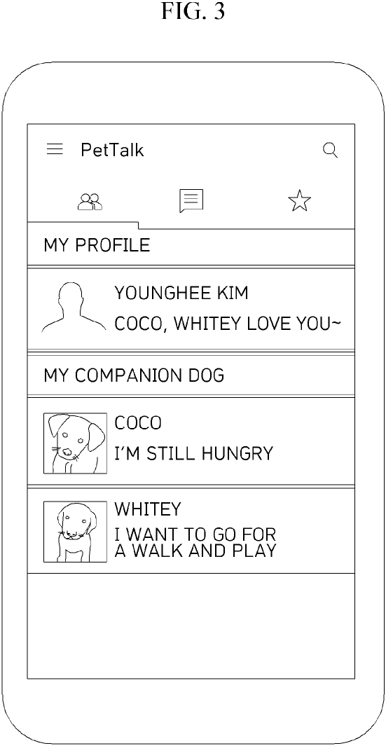

FIGS. 3 to 5 are exemplified views illustrating an executed screen of the companion animal communication-dedicated application according to the embodiment of the present invention.

According to the embodiment, as illustrated in FIG. 3, the companion animal communication-dedicated application provides the chat function for setting the companion animal to be a conversation partner.

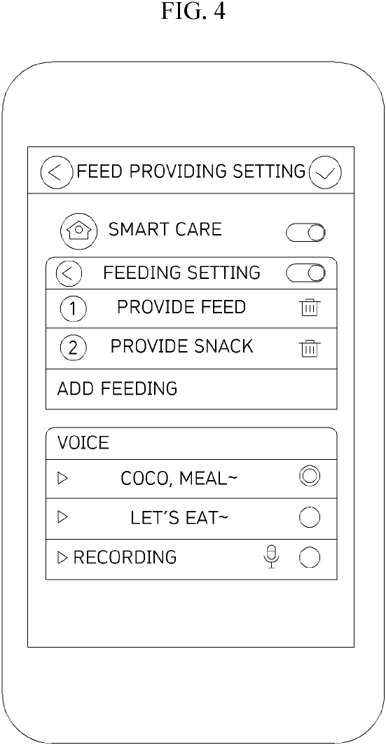

In addition, as illustrated in FIG. 4, the companion animal communication-dedicated application may provide a function of presetting the remote control signal capable of controlling the operation of the desire-satisfying device 50 through the control signal relay device 30. For example, the companion animal communication-dedicated application may allow the user to preset or edit a time to provide feed or snack so that the remote control signal for supplying the feed and snack to the feeder and the snack feeder is transmitted at predetermined intervals Alternatively, the companion animal communication-dedicated application may allow the user to set or edit a specific time so that the remote control signal for providing the feed or snack at the specific time is transmitted.

The companion animal communication-dedicated application may allow the user to set a limit on the amount of feed or snack that may be provided to the companion animal.

After the amount that the companion animal eats per day is adjusted, the feed is provided whenever the companion animal asks. And when the companion animals eat the set amount of feed, even though the companion animal presses the desire button, the desire button is deactivated so that the LED does not light up and no sound is outputted. Therefore, the companion dog may be educated to know that he/she is not able to eat any more when he/she sees that the LED doesn’t light up and no sound is outputted.

In this case, when the companion dog presses the desire input button while the desire button is deactivated, the owner may check a message in the form of a push and provide the companion dog with additional feed if the owner wants the additional feeding.

Therefore, it is possible to prevent behavior, which cause vomiting, such as binge-eating in the evening even though the feed is provided every predetermined time, and to manage the health and diet of the companion animal.

In addition, the companion animal communication-dedicated application may further provide a function of allowing the user to directly generate, store a voice recording file and set an output time of the voice recording file so that the user’s voice signal such as “Let’s eat a feed” and “Let’s eat a snack” is outputted through the control signal relay device 30 or the speaker provided in the feeder or the snack feeder itself at the set time to provide feed or snack.

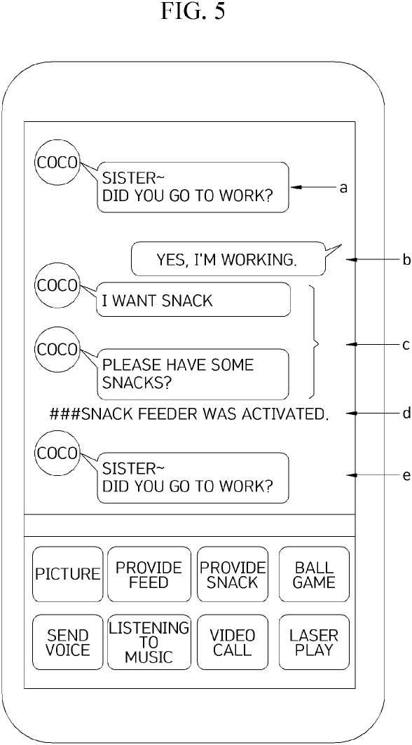

In addition, as illustrated in FIG. 5, the companion animal communication-dedicated application according to the embodiment delivers the desire content of the companion animal as if the user communicates with the companion animal using the chat function.

The desire signal delivery unit 120 inputs a content for starting a conversation through the companion animal communication-dedicated application of the user terminal 20 when the companion animal presses the desire input button 40 (a). In this case, the desire signal delivery unit 120 may generate and output an appropriate message suitable for the situations based on time information, schedule information stored in the user terminal, and location information.

In this case, the desire signal delivery unit 120 may be implemented to optionally send a message based on the time information, the schedule information stored in the user terminal 20, and the user location even though the companion animal does not press the desire input button.

The companion animal communication-dedicated application generates a conversation message based on a learning content in the deep learning unit 160. In this case, the companion animal communication-dedicated application may monitor chatting contents with others through the chat application running in the user terminal 20, and to generate and output a message based on the user’s chatting contents. Of course, in this case, whether to link the chatting contents with others may be determined by the user’s choice.

Then, the user may input feedback by responding through the companion animal communication-dedicated application (b).

Thereafter, the desire signal delivery unit 120 outputs a colloquial message suitable for the desire situation of the companion animal according to the type of desire input button 40 pressed by the companion animal through the companion animal communication-dedicated application (c).

When a signal of a button placed around the snack is input or a signal of a button that the companion animal presses when he/she desires to eat the snack by training is input, the desire signal delivery unit 120 may identify the desire content for the snack corresponding to the button signals.

In this case, when a delay time until the user’s feedback is input is equal to more than a predetermined time, a contextual conversation, such as “Why are you late in answering?” and “What’s wrong with you?” is further input, thereby giving a sense of reality like chatting with someone else instead of the companion animal.

Thereafter, the user may instantly select a “provide snack” menu through the companion animal communication-dedicated application.

Then, the remote control signal is transmitted to the corresponding desire-satisfying device 50 to satisfy the desire of the companion animal through the control signal relay device 30 provided in the house. In this case, the control signal relay device 30 having an IoT function transmits the control signal to the snack feeder to provide the snack, and may upload a snack-providing notification and a video shot around the snack feeder through the chat window of the companion animal communication-dedicated application

In addition, the control signal relay device 30 obtains a message notifying that the snack is completely provided after the snack feeder completely provides the snack and transmits the message to the communication function-providing device 10. Then, the user may check the message notifying that the snack has been provided to the companion animal by the snack feeder though the chat window with the companion animal (d).

In addition, the user may check the video of the companion animal eating the snack in real time through the chat window with the companion animal. When a predetermined amount of time passes after the snack is provided, or when the companion animal disappears from the video shot around the snack feeder, the companion animal communication-dedicated application may further output a message related to satisfying the desire through the chat window (e).

In a further aspect, the companion animal communication-dedicated application may further provide an expert coaching function. The companion animal communication-dedicated application provides the expert coaching function in the format of directly asking questions to a companion animal expert and receiving answers to questions from the expert for information necessary for companion animal training or an analysis content according to behavior type of the companion animal.

The expert coaching function may be implemented, for example, in the form of uploading questions to a bulletin board and receiving answers, or in the form of creating a chat channel with an expert so that it is possible to make a conversation by chatting with an expert such as a companion animal behavior corrector. However, the present invention is not limited thereto.

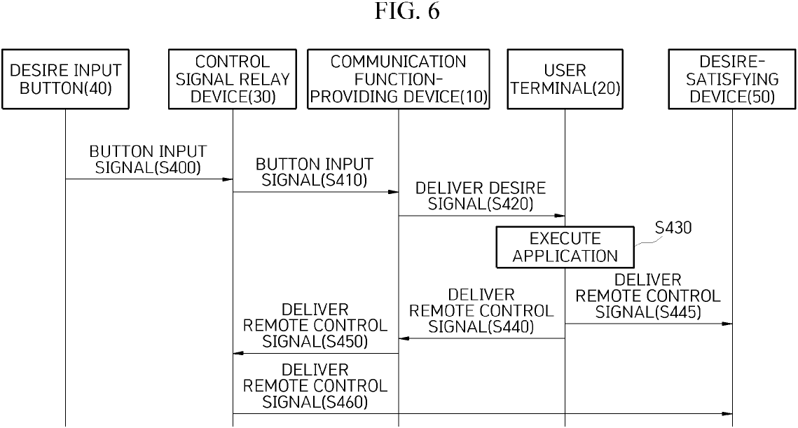

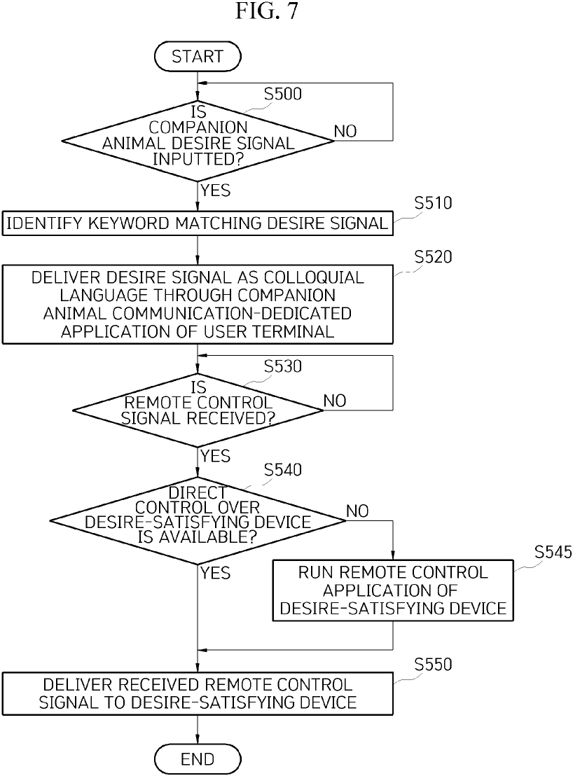

FIGS. 6 and 7 are flowcharts for explaining a method of providing a function for communication with a companion animal based on the Internet of Things according to an embodiment of the present invention.

The method of providing a function for communication with a companion animal based on the Internet of Things according to the embodiment will be described in detail. As illustrated in FIG. 6, first, when the desire input button is pressed, the control signal relay device 30 (main terminal) receives a button input signal from the desire input button 40 (S400).

Then, after the control signal relay device 30 transmits the button input signal to the communication function-providing device 10 (S410), the communication function-providing device 10 sends a refined content to the companion animal communication-dedicated application of the user terminal.

That is, the communication function-providing device 10 delivers a desire signal to the user terminal 20 (S420). In this case, the companion animal communication-dedicated application may output the desire signal to enable two-way communication in the form of a messenger and receive a remote control signal therefor. Alternatively, the companion animal communication-dedicated application may be implemented in conjunction with an existing chat-only application running in the user terminal 20 to enable two-way communication.

That is, when the companion animal expresses the desire acquired by training through the button, the communication function-providing device 10 makes and refines the button input as data, and the companion animal communication-dedicated application of the user terminal 20 may allow the user to communicate with the companion animal as if the companion animal were talking using an actual language.

The user inputs a remote control signal corresponding to the desire of the companion animal through the companion animal communication-dedicated application running in the user terminal 20 (S430).

The remote control signal includes control signals for controlling the operations of various desire-satisfying devices 50, such as a signal for controlling the feed supply of the feeder, a signal for controlling the snack supply of the snack feeder, and a signal for operating the ball game machine.

Then, the user terminal 20 delivers the remote control signal to the communication function-providing device 10 (S440), and the communication function-providing device 10 delivers the remote control signal to the control signal relay device 30 (S450) .

According to another embodiment, the user may input the remote control signal through various applications capable of transmitting the remote control signal to the desire-satisfying device as well as the companion animal communication-dedicated application running in the user terminal 20.

That is, in case that the desire-satisfying device 50 is not connected to the control signal relay device 30 as well as the companion animal communication-dedicated application running in the user terminal 20, the user may call, activate and operate another application capable of controlling the desire-satisfying device 50 corresponding to the desire of the companion animal from the companion animal communication-dedicated application, directly transmit the remote control signal to the desire-satisfying device 50, and execute the desire-satisfying device 50 (S445).

Meanwhile, the control signal relay device 30 selects the desire-satisfying device 50 matched with the remote control signal and delivers the remote control signal to the selected desire-satisfying device 50 (S460).

Examples of the desire-satisfying device 50 include various apparatuses that may operate in response to the remote control signal. For example, the desire-satisfying device 50 includes one of a feeder, a snack feeder, a puppy laser machine, a ball game machine, and a video call apparatus. However, the desire-satisfying device 50 is not limited thereto, but is interpreted to encompass various devices and apparatuses that may operate in response to the remote control signal and may satisfy the desire of the companion animal.

FIG. 7 illustrates a method of providing a function for communication with a companion animal based on the Internet of Things according to an embodiment, which is performed by the device for providing a function for communication with a companion animal based on the Internet of Things including the desire signal delivery unit, the remote control signal reception unit, and the remote control signal delivery unit. As illustrated in FIG. 7, first, when a desire signal of the companion animal is input into the desire signal delivery unit (S500), the desire signal delivery unit identifies a keyword according to the desire signal (S510) . In this case, the keyword according to the desire signal may be differently preset for each button. That is, the desire signal is input according to the button input that is set differently for each desire of the companion animal.

Further, the communication function-providing device delivers the desire signal through the companion animal communication-dedicated application running in the user terminal (S520) .

In one aspect, the delivering of the desire signal includes converting the desire signal of the companion animal into a colloquial language and delivering the converted desire signal through the chat function of the companion animal communication-dedicated application.

Specifically, the delivering of the desire signal includes identifying a keyword according to the desire signal of the companion animal, selecting a sentence including the identified keyword from among the pre-stored conversational sentences, and delivering the selected sentence through the chat function of the companion animal communication-dedicated application.

The communication function-providing device may selectively send the contents to the user terminal on the basis of the current time information and the previous data executed by the desire-satisfying device when the desire input button is repeatedly pressed several times. In addition, the user may set the number of uses, usage time and the like of each desire-satisfying device and deactivate the desire button so that a voice output and LED lighting do not work even though the desire button is pressed. For example, when the desire button is repeatedly pressed within a predetermined time, this operation may be deactivated.

For example, when an input signal of the o-shaped button matched with a keyword ‘feed’ is received, one of the colloquial sentences that may express the corresponding desire such as ‘I’m hungry’ and ‘It’s time to eat! Please be with me’ is selected and delivered through the chat window of the user terminal.

In another aspect of the present invention, the delivering of the desire signal includes converting the desire signal of the companion animal into a colloquial language through the chat function of the companion animal communication-dedicated application on the basis of a companion animal shooting video received from the camera and delivering the converted desire signal.

For example, when the companion animal eats a feed and moves away from the feeder after the feed has been provided, it is possible to send the colloquial language notifying the situation, such as “I’ve finished eating.”

Thereafter, when the remote control signal reception unit receives the remote control signal of the desire-satisfying device matched with the desire signal delivered by the desire signal delivery unit through the companion animal communication-dedicated application running in the user terminal (S530), the remote control signal reception unit confirms whether the control signal may be transmitted directly to the desire-satisfying device (S540). Further, when it is confirmed that the control signal may be transmitted directly to the desire-satisfying device, the remote control signal delivery unit delivers the remote control signal received by the remote control signal reception unit to the desire-satisfying device (S550) .

In contrast, when it is confirmed that the control signal may not be transmitted directly to the desire-satisfying device, an application which is separately installed in the user terminal and performs a function to remotely control the desire-satisfying device is first operated (S545), and the remote control signal is delivered to the desire-satisfying device through the application performing the function to remotely control the desire-satisfying device.

The remote control signal includes control signals capable of controlling operations of various desire-satisfying devices, such as a signal for controlling the feed supply of the feeder, a signal for controlling the snack supply of the snack feeder, and a signal for operating the ball game machine.

The desire-satisfying device may be implemented as a feeder or snack feeder to satisfy an appetite of the companion animal. In addition, the desire-satisfying device may be implemented as a play-aid such as a puppy laser machine or a ball game machine to satisfy a play desire of the companion animal. In addition, the desire-satisfying device may be implemented as a video call apparatus to satisfy a desire to miss the owner of the companion animal.

Alternately, the desire-satisfying device may be implemented to output the user’s voice through a speaker equipped on the control signal relay device or a physically separated speaker.

Additionally, the communication function-providing device according to the embodiment may be implemented to receive feedback on satisfying the desire of the companion animal from the desire-satisfying device and transmit the feedback to the user terminal.

The above-mentioned method may be implemented as applications or may be in the form of program instructions executable through various computer elements, and then recorded in a computer-readable recording medium. The computer-readable recording medium may include program instructions, data files, data structures, or the like, in a stand-alone form or in a combination thereof.

The program instructions recorded in the computer-readable recoding medium may be designed and configured specifically for the present invention or may be publicly known and available to those skilled in the field of computer software.

Examples of the computer-readable recording medium may include magnetic media, such as a hard disk, a floppy disk and a magnetic tape, optical recording media, such as CD-ROM and DVD, magneto-optical media, such as a floptical disk, and hardware devices, such as ROM, RAM and flash memory, which are specifically configured to store and run program instructions.

Examples of the program instructions include machine codes made by a compiler, as well as high-language codes that may be executed by a computer, using an interpreter. The above hardware devices may be configured to operate as one or more software modules in order to perform the operation according to the present invention, and vice versa.

While the present invention has been described above with reference to the embodiments, it may be understood by those skilled in the art that the present invention may be variously modified and changed without departing from the spirit and scope of the present invention disclosed in the claims.

1. A device for providing a function for communication with a companion animal based on the Internet of Things, the device comprising:
a desire signal delivery unit configured to receive a desire signal of a companion animal and deliver the desire signal through a companion animal communication-dedicated application running in a user terminal;
a remote control signal reception unit configured to receive a remote control signal of a desire-satisfying device matched with the desire signal delivered by the desire signal delivery unit through the companion animal communication-dedicated application running in the user terminal; and
a remote control signal delivery unit configured to deliver the remote control signal received by the remote control signal reception unit to the desire-satisfying device.

2. The device of claim 1, wherein the desire signal delivery unit converts the desire signal of the companion animal into a colloquial language and delivers the converted desire signal through a chat function of the companion animal communication-dedicated application.

3. The device of claim 2, wherein the desire signal delivery unit identifies a keyword according to the desire signal of the companion animal, selects a sentence including the keyword from among pre-stored conversational sentences, and transmits the selected sentence through the chat function of the companion animal communication-dedicated application.

4. The device of claim 2, wherein the desire signal delivery unit converts the desire signal of the companion animal into the colloquial language and transmits the converted desire signal through the chat function of the companion animal communication-dedicated application on the basis of a companion animal shooting video received from a camera.

5. The device of claim 1, wherein the desire-satisfying device is at least one of a feeder, a snack feeder, a play-aid, a video call device, and a speaker.

6. The device of claim 1, wherein the desire signal delivery unit receives the desire signal according to a button input set differently for each desire of the companion animal.

7. A user terminal equipped with the device for providing a function for communication with a companion animal based on the Internet of Things according to claim 1.

8. A method of providing a function for communication with a companion animal based on the Internet of Things performed by a device for providing a function for communication with a companion animal based on the Internet of Things including a desire signal delivery unit, a remote control signal reception unit, and a remote control signal delivery unit, the method comprising:
receiving, by the desire signal delivery unit, a desire signal of a companion animal and delivering, by the desire signal delivery unit, the desire signal through a companion animal communication-dedicated application running in a user terminal;
receiving, by the remote control signal reception unit, a remote control signal of a desire-satisfying device, the remote control signal matching with the desire signal delivered by the desire signal delivery unit through the companion animal communication-dedicated application running in the user terminal; and
delivering, by the remote control signal delivery unit, the remote control signal to the desire-satisfying device, the remote control signal being received by the remote control signal reception unit.

9. The method of claim 8, wherein the delivering of the desire signal comprises converting the desire signal of the companion animal into a colloquial language through a chat function of the companion animal communication-dedicated application and delivering the converted desire signal.

10. The method of claim 9, wherein the delivering of the desire signal comprises identifying a keyword according to the desire signal of the companion animal, selecting a sentence including the keyword from among pre-stored conversational sentences, and delivering the selected sentence through the chat function of the companion animal communication-dedicated application.

11. The method of claim 9, wherein the delivering of the desire signal comprises converting the desire signal of the companion animal into the colloquial language through the chat function of the companion animal communication-dedicated application on the basis of a companion animal shooting video received from a camera, and delivering the converted desire signal.

12. The method of claim 8, wherein the desire-satisfying device is at least one of a feeder, a snack feeder, a play-aid, a video call device, and a speaker.

13. The method of claim 8, wherein the delivering of the desire signal comprises receiving the desire signal according to a button input set differently for each desire of the companion animal.
